(19) United States
(12) Patent Application Publication
(10) Pub. No.: US 2009/0187418 A1
(43) Pub. Date: Jul. 23, 2009

(54) Methods and Systems for Outputting a List of Complementary Treatments for a Patient

(76) Inventor: Pierre Sioui, Mont-Saint-Hilaire (CA)

Correspondence Address: OGILVY RENAULT LLP, 1, Place Ville Marie, SUITE 2500, MONTREAL, QC, H3B 1R1, CA

(21) Appl. No.: 11/936,760

(22) Filed: Nov. 7, 2007

Related U.S. Application Data
(60) Provisional application No. 60/857,129, filed on Nov. 7, 2006.

(51) Int. Cl. G06Q 50/00; G06Q 30/00

(52) U.S. Cl. 705/2; 705/26

(57) ABSTRACT

There is described a method for outputting a list of complementary treatments for a patient using a complementary treatment database which comprises entries for prescription drugs and complementary treatments associated to at least some of the prescription drugs. The method comprises: inputting a drug search criteria on a user interface, the drug search criteria corresponding to an identification of a drug prescribed to the patient; obtaining, from the complementary treatment database, a list of complementary treatments matching the drug search criteria and hence adapted to the prescribed drug; and outputting the list of complementary treatments on the user interface for consultation.

### CROSS-REFERENCE TO RELATED APPLICATIONS

This patent application claims priority under 35 U.S.C. §119 from U.S. Provisional Patent Application No. 60/857,129 filed Nov. 7, 2006 which is hereby incorporated by reference.

### TECHNICAL FIELD

The description relates generally to databases, data processing systems and software applications. More specifically, the context is pharmacy or dispensary applications.

### BACKGROUND OF THE ART

There is an increasing trend presently in the quantity of prescription drugs being prescribed. An increase in prescription drug consumption for a patient results in an increase in the possible contraindications between medical treatments. The contraindications may be the results, for example, of an incompatibility between two prescription drugs, between a prescription drug and an over-the-counter drug, or between a prescription drug and any other form of medical treatment. Also, there is the possibility that, for a given prescription drug, there is a recommended other prescription drug, over-the-counter drug, vitamins, supplements, or other form of medical or non-medical treatment or monitoring which may be recommended (i.e., a complementary treatment) in view of the effects of the given prescription drug.

### SUMMARY

The methods, systems and software applications described herein are for a tool which is capable of determining whether a prescribed drug, a life style habit, a pathology are associated or not with one or more complementary medical treatment. The tool is capable of providing an explanation for the proposed treatment and suggested products. It is also possible to obtain supplementary information on the suggested products. Within this information, it is possible to find promotions, documents for the client/patient and/or for the pharmacist giving arguments on the validity of the treatment. All such documents can be printed.

Furthermore, the tool includes billing schemes for selling a position in the suggested product lists or the list of complementary treatments. The tool is also capable of launching the creation of prescriptions in the pharmacy software application. It is also an option to obtain statistics concerning the supplementary sales launched by the use of the complementary therapy module.

Hence the described tool is provided to pharmacists: to propose products/advice for enhancing the efficiency of the prescribed drug; to manage promotion campaigns for pharmaceutical companies; to consult supplementary information concerning available complementary treatments; to enhance quality of life of a patient by optimizing his therapy/treatment; to guide the pharmacist through the possible complementary treatments associated with a prescribed drug; to give supplementary information to the pharmacist as well as to the patient on the suggested product; to create the opportunity, for pharmaceutical companies, to publicize certain products; to obtain substantial revenues from pharmaceutical companies for product referral as well as for posting of promotions; and to increase revenues for pharmacist owners.

In one aspect, the present description provides a method for outputting a list of complementary treatments for a patient using a complementary treatment database which comprises entries for prescription drugs and complementary treatments associated to at least some of the prescription drugs. The method comprises: inputting a drug search criteria on a user interface, the drug search criteria corresponding to an identification of a drug prescribed to the patient; obtaining, from the complementary treatment database, a list of complementary treatments matching the drug search criteria and hence adapted to the prescribed drug; and outputting the list of complementary treatments on the user interface for consultation.

In another aspect, the present description provides a computer-readable medium encoded with processing instructions for implementing a method performed by a computer. The method for outputting a list of complementary treatments for a patient using a complementary treatment database which comprises entries for prescription drugs and complementary treatments associated to at least some of the prescription drugs. The method comprises: inputting a drug search criteria on a user interface, the drug search criteria corresponding to an identification of a drug prescribed to the patient; obtaining, from the complementary treatment database, a list of complementary treatments matching the drug search criteria and hence adapted to the prescribed drug; and outputting the list of complementary treatments on the user interface for consultation.

In another aspect, the present description provides a system for outputting a list of complementary treatments for a patient. The system comprises: a user interface giving access to a network; a complementary treatment database accessible via the network, the complementary treatment database comprises entries for prescription drugs and complementary treatments associated to at least some of the prescription drugs; and a server processing unit coupled to the network and comprising a memory encoded with processing instructions for allowing the processor to: input a drug search criteria on the user interface, the drug search criteria corresponding to an identification of a drug prescribed to the patient; obtain, from the complementary treatment database, a list of complementary treatments matching the drug search criteria and hence adapted to the prescribed drug; and output the list of complementary treatments on the user interface for consultation.

Further details of these and other aspects will be apparent from the detailed description and figures included below.

### DESCRIPTION OF THE DRAWINGS

Reference is now made to the accompanying Figures depicting aspects of the present description, in which:

FIG. 1 is a block diagram providing an overview of the environment in which embodiments of systems and methods for outputting a list of complementary treatments for a patient are implemented;

FIG. 2 is a flow chart illustrating an exemplary embodiment of a method for outputting a list of complementary treatments for a patient;

FIG. 3 is a flow chart illustrating an exemplary embodiment for the step of identifying a drug prescribed to a client in the method of FIG. 2;

FIG. 4 is a flow chart illustrating an exemplary embodiment for the step of obtaining a list of complementary treatments adapted to the prescribed drug in the method of FIG. 2;

FIG. 5 is a flow chart illustrating an exemplary embodiment for the step of outputting the list of complementary treatments in the method of FIG. 2;

FIG. 6 is a screen shot of the user interface for showing the details of a given complementary treatment according to an embodiment;

FIG. 7 is a screen shot of the user interface for showing a page proposing complementary treatments according to an embodiment; and

FIG. 8 is a screen shot for showing a user interface for a given drug selected from the list provided on the user interface of FIG. 7.

### DETAILED DESCRIPTION

Definitions. The method for outputting a list of complementary treatment may also be referred to as a method for suggesting, proposing, recommending, or providing a complementary treatment to a client/patient or a list of complementary treatment to a client/patient. A complementary treatment for a prescription drug relates to an effect of the prescription drug. It can include, but is not limited to another other prescription drug, over-the-counter drug, vitamins, supplement, or other form of medical or non-medical treatment/service or monitoring which may be recommended (e.g., monitor blood pressure, sugar level, etc. at a given frequency). The identification of a drug (or prescription drug) is meant to include, but is not limited to, the commercial name of the drug, the scientific name of the drug, the chemical name of the drug, the DIN, or any other code that refers to the drug. Incompatible treatments may be the results, for example, of incompatibility between two prescription drugs, between a prescription drug and an over-the-counter drug, between a prescription drug and any other form of medical treatment, or between a prescription drug and a condition of the patient or any other characteristic concerning the patient.

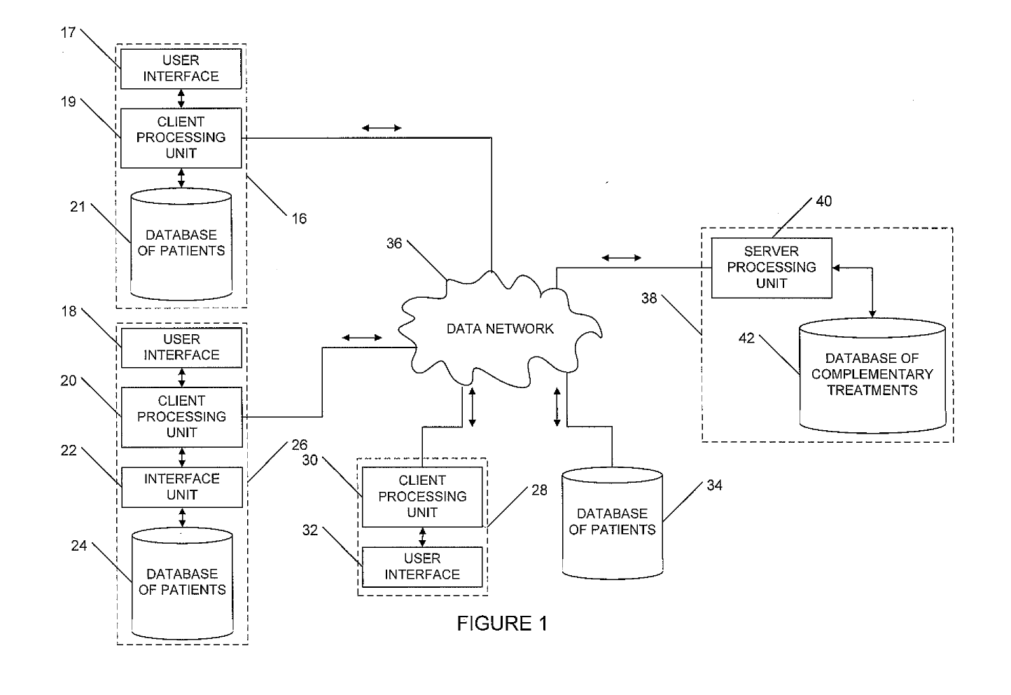

Turning to FIG. 1, there is shown a block diagram providing an overview of the environment in which embodiments of the systems and methods for outputting a list of complementary treatments for a patient are implemented. The environment may include several client-side processing systems (which are labelled here as 16, 26 and 28), a server-side processing system 38 and a data network 36.

FIG. 1 shows three different embodiments for a client-side processing system. In one embodiment, client-side processing system 16 is illustrated. Client-side processing system 16 comprises a user interface 17, a client processing unit 19 and a database of patients 21. In another embodiment, client-side processing system 28 is illustrated. In this embodiment, client-side processing system 28 includes only the client processing unit 30 and the user interface 32. The database of patients 34 is shown separately from the client-side processing system 28. In yet another embodiment, the client-side processing system 26 is illustrated. In this embodiment, client-side processing system 26 includes a user interface 18, a client processing unit 20, an interface unit 22 and a database of patients 24. Interface unit 22 may be necessary, for example, in the case where the database of patients 24 is not compatible with the client processing unit 20 or cannot directly communicate with the client processing unit 20 (e.g., translation in the format of the information is necessary).

The server-side processing system 38 may comprise a server processing unit 40 in communication with a database of complementary treatments 42. The server-side processing system 38 may also comprise a server user interface (not shown) which is used to interface with the database of complementary treatments 42 or any other part of the server-side processing system 38.

Server-side processing system 38, client-side processing system 16, client-side processing system 26, client-side processing system 28 and database of patients 34 communicate with each other through data network 36.

In one embodiment, the server processing unit 40 may include two types of servers (not shown): a server where the data are stored and another server for holding the administration WEB pages and the WEB services for communicating the data with the client station. Two types of solutions can apply for communication between the server and the client station. In one embodiment, the WEB services were selected over the WEB pages.

In one embodiment, the server processing unit 40 may include a Management Module (not shown) and Reporting Module (not shown). The Management Module functions include, but are not limited to: identification of the administrator; association/dissociation of the products launching a complementary treatment; creation/modification of a complementary therapy associated with prescribed drug; association/dissociation of suggested products with a complementary treatment; association/dissociation of references to complementary treatments; and association/dissociation of references to products. The Reporting Module functions include, but are not limited to, reporting on the number of entries in the module.

In one embodiment, the client processing unit 16, 20, or 30 may include a Complementary Treatment Consultation Module. The Complementary Treatment Consultation Module functions include, but are not limited to: session opening; detecting complementary treatments; consulting the list of complementary treatments; consulting a complementary treatment; and consulting the detailed description of a product;

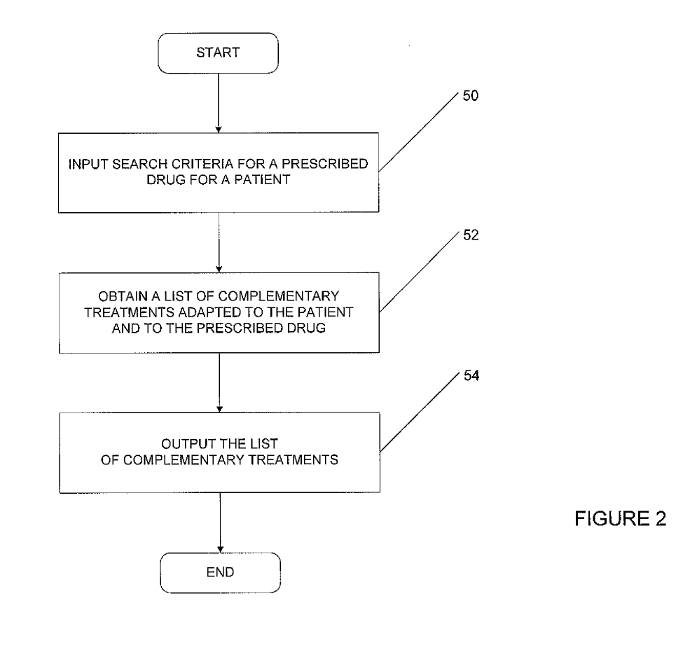

Now turning to FIG. 2, there is shown a method for outputting a list of complementary treatments for a patient. The method can be embodied in a software application that can be referred to as a pharmacy software application or a dispensary software application.

The method includes inputting a drug search criteria on a user interface. The drug search criteria corresponds to the identification of a drug prescribed to a patient (step 50). Using the identification of the prescribed drug, a database of complementary treatments is consulted to obtain therefrom a list of complementary treatments which match the drug search criteria and are hence adapted to the prescribed drug (step 52).

In one embodiment, a database comprising information about patients may be consulted. It is useful to consult the database of patients since some of the complementary treatments may not be adapted to the particular condition of each patient. Therefore after consulting the database of patients, the list of complementary treatments may be altered. Such an embodiment may include the steps of inputting, on the user interface, a patient search criteria corresponding to an identification of a given one of the patients; obtaining, from the database of patients, a list of incompatible treatments and previous and present treatments for the given patient matching the patient search criteria. Furthermore, the step of obtaining the list of complementary treatments (step 52) comprises comparing the list of incompatible treatments and previous and present treatments for the patient matching the patient search criteria with the list of complementary treatments matching the drug search criteria, and producing the list of complementary treatments using the comparison of lists.

The list of the complementary treatments is then outputted on the user interface (step 54) for consultation by a user (e.g., pharmacist, patient, other professional, clerk, etc.).

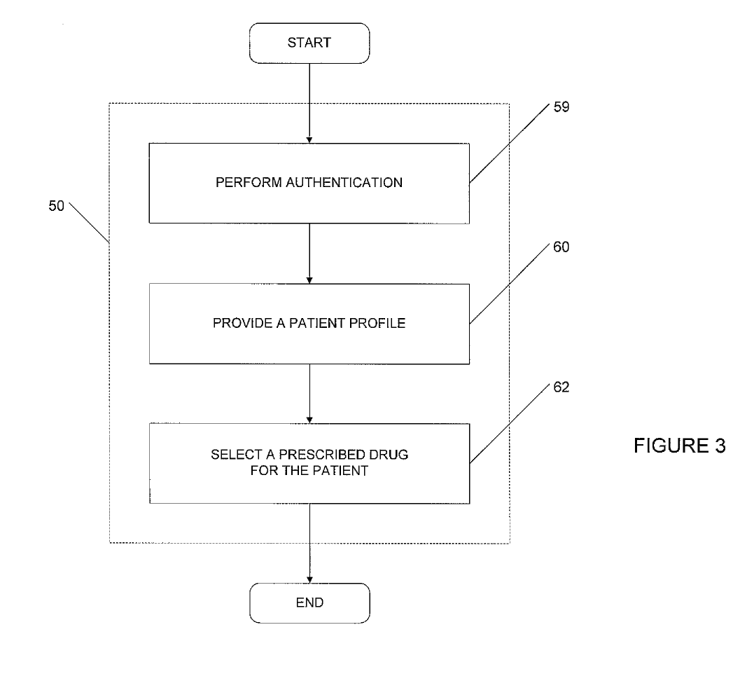

Now turning to FIG. 3, step 50 (from FIG. 2) of providing the identification of a drug prescribed to a patient is further detailed. First off, the user logging on to the system is authenticated at step 59. Then the user, which may be a pharmacist, inputs a patient profile at step 60. Finally, the user selects, for example from a drop down menu, or inputs to the user interface an identification of the drug prescribed to the patient (step 62).

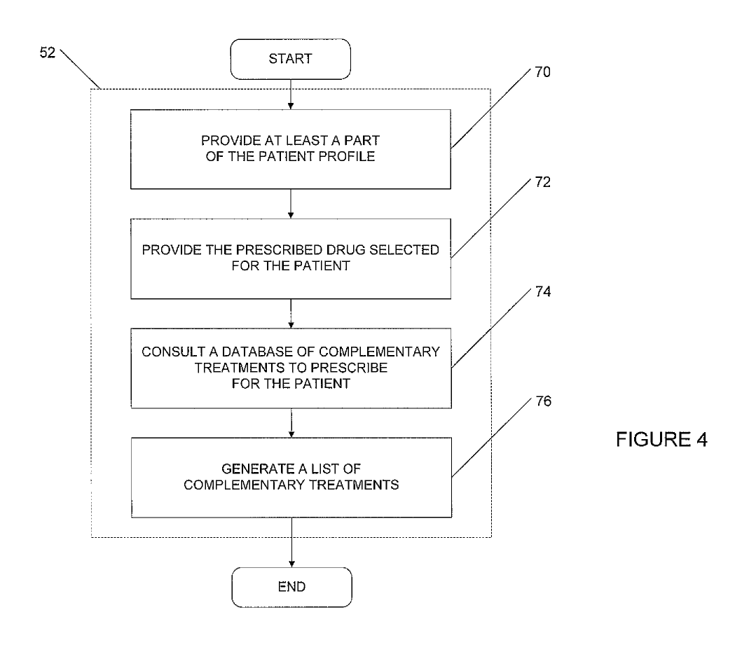

Now turning to FIG. 4, further details of the step of obtaining a list of complementary treatments adapted to the prescribed drug (step 52 from FIG. 2) is further discussed. According to an embodiment, the patient profile is provided to the server-side processing system at step 70. Then, the identification of the prescribed drug is provided to the server-side processing system at step 72. Then, the database of complementary treatments is consulted given the condition or specific details concerning the patient (step 74). Finally, at step 76, the server processing unit uses the patient profile along with the list of complementary treatments provided by the database of complementary treatments and generates the final list of complementary treatments.

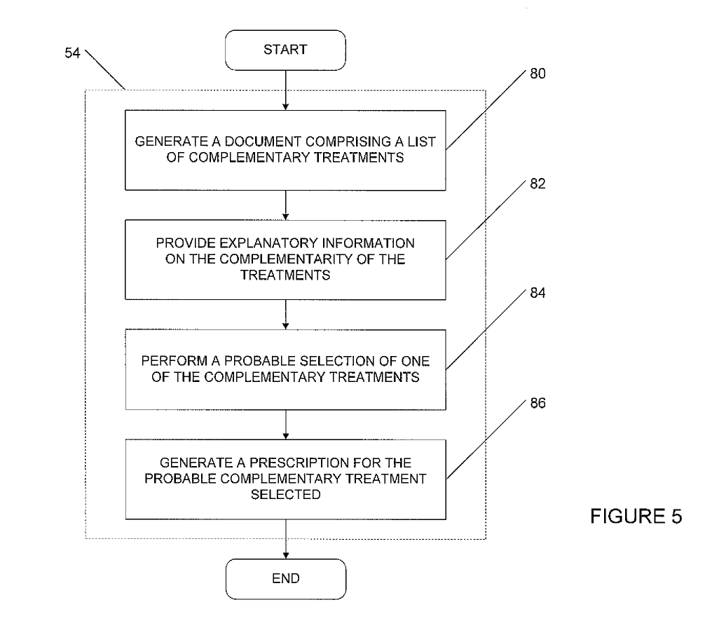

Now turning to FIG. 5, the step of outputting the list of complementary treatments (step 54 from FIG. 2) is further detailed. At step 80, the client processing unit generates a document comprising the final list of complementary treatments. At step 82, the document is further enhanced by providing explanatory information regarding the complementarity of the drugs proposed in the complementary treatment. At step 84, a selection of a complementary treatment (for example, to take a complementary drug) is performed. In the case where the complementary treatment includes a prescription drug, a prescription is generated for the selected prescription drug (step 86). Even though, it is not shown specifically in the Figures, all documents produced during the process, or all parts of documents produced during the process, can be printed on site or elsewhere.

Other steps in the method not specifically described in a Figure may be described as follows. Step 84 of selecting a complementary treatment may further comprise selecting a prescription drug. The method may then further comprises preparing and printing a prescription for the prescription drug.

In another embodiment, the method further comprises providing supplementary information concerning the selected complementary treatment. The supplementary information may comprise at least one of a promotion for a product, a document for the patient, and a document for the pharmacist giving arguments on the validity of the treatment.

In yet another embodiment, step 84 of selecting a complementary treatment triggers a query to the complementary treatment database which outputs, to the user interface, a list of products or services corresponding to the complementary treatment. The method may then further include selecting a product or service from the list of products or services corresponding to the complementary treatment. The method may yet further include making a sale of the product or service. The sale may be recorded.

In another embodiment, the method may include selling the position at which a product or service appears in the list of products or services.

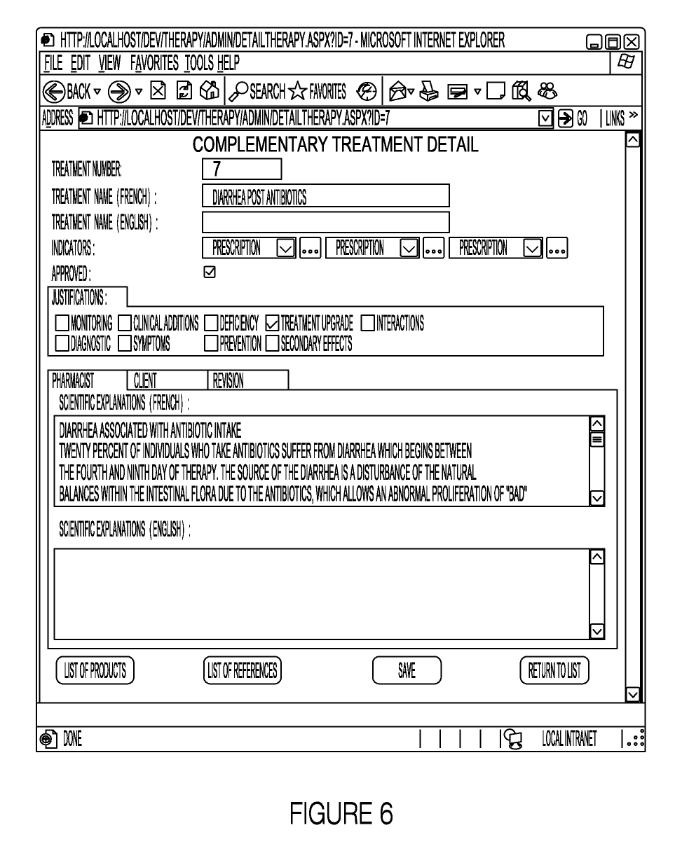

Now, turning to FIG. 6, there shown a screen shot of the user interface for giving the details of a given complementary treatment. The screen shot shown in FIG. 6 is partly in the French language. A translation of some of the terms and their description follows. The field identified as “numéro de traitement” translates to “Treatment Number”. This is simply a reference number given to the treatment. The field below it is labelled “nom du traitement (français)” and translates to “Treatment Name (French)” and is self-explanatory. The field below it is labelled “nom du traitement (anglais)” and translates to “Treatment Name (English)”. This field is also self-explanatory. The field below the latter one is labelled “indicateurs” and translates to “Indicators”. This field comprises a series of drop down menus for given prescriptions (“ordonnance”). The field below the latter one is labelled “approuvé” and is simply a check box to let the user know if the proposed or selected complementary treatment is approved. The tab underneath is labelled “justification” and translates to “justification” or “reason”. This tab comprises a series of checked boxes which indicate why the complementary treatment can be useful. Some examples include monitoring, diagnostic, symptoms, prevention, secondary effects, enhancement of treatment, interaction, deficiency, etc. The next portion of the user interface shows a box having three tabs, the first tab is labelled “pharmacien” which translates to “Pharmacist”, a second tab is labelled “client” which translates to “Client”, and finally the third tab is labelled “révision” which translates to “Revision”. The Pharmacist tab is presently shown as selected and shows two fields. A first field is labelled “explications scientifiques (français)” which translates to “Scientific Explanations (French)” and a second field which is labelled “explications scientifiques (anglais)” translates to “Scientific Explanations (English)”. Both fields are self-explanatory. Finally, a series of hyperlinks are shown at the bottom of the user interface, the hyperlinks are labelled “liste des produits” which translates to “List of Products”, “liste des références” which translates to “List of References”, “sauvegarder” which translates to “Save”, and finally, “retour àla liste” which translates to “Return to List”.

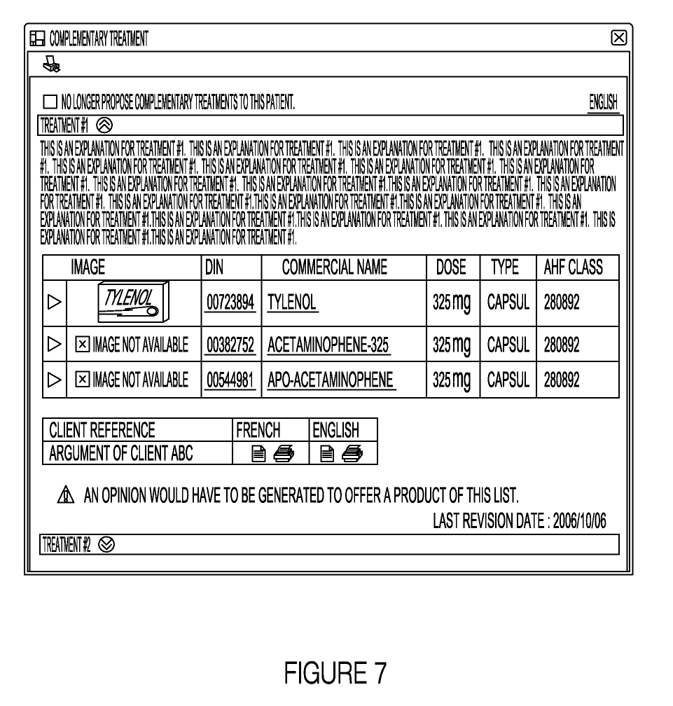

Now turning to FIG. 7, a user interface for a page proposing a complementary treatment is shown. The user interface is in French and the translation follows. First, a check box labelled “ne plus proposer les traitements complémentaires à ce patient” translates to “No longer propose the complementary treatment to this patient”. The result of checking this box is self-explanatory. Then, the label “traitement #1” is shown and translates to “Treatment #1”. This is simply an identification of a given treatment. The text that follows is an explanation of the given treatment. Under this explanation, there is shown a list of possible drugs that can be used for this given treatment with, for example, an image showing the drug or its trademark, the DIN for the drug, its commercial name, its strength, the form which it takes, and the AHF Class.

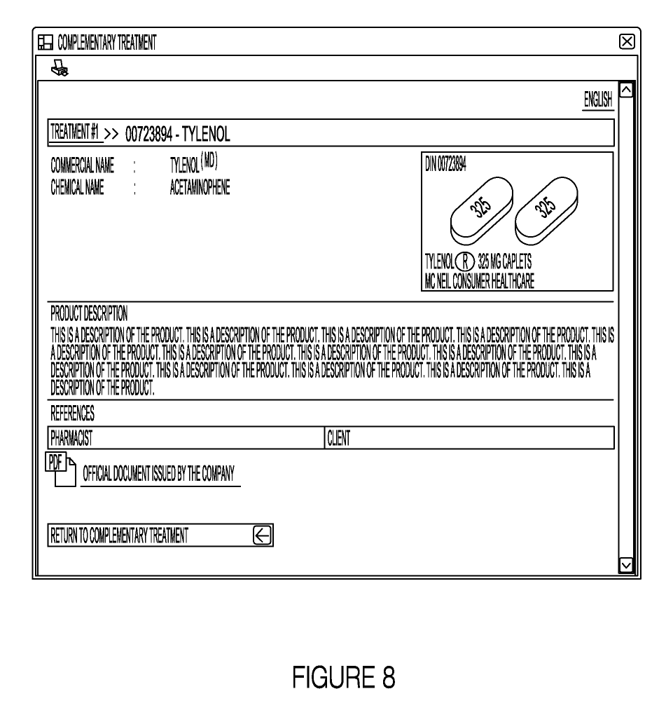

Now turning to FIG. 8, there shown a user interface for a given drug selected from the list provided on the user interface of FIG. 7. In this case, the drug Tylenol® was selected to fulfill the given complementary treatment. The information concerning the drug is provided on the user interface. First, its commercial name (“nom commercial”) is given. Second, its chemical name (“nom chimique”) is given. Third, the description of the product (“description du produit”) is given. Then, there is the possibility of adding references (“references”) for the pharmacist (“pharmacien”) or the client/patient. In this example, a link to a “pdf” document which is an official document issued by the company is shown. Finally, at the bottom of this user interface page, a hyperlink to return to the previous complementary treatment page is provided (“retour au traitement complémentaire”).

The above description is meant to be exemplary only, and one skilled in the art will recognize that changes may be made to the embodiments described without department from the scope of the invention disclosed. Modifications which fall within the scope of the present invention will be apparent to those skilled in the art, in light of a review of this disclosure, and such modifications are intended to fall within the appended claims.

What is claimed is:

1. A method for outputting a list of complementary treatments for a patient using a complementary treatment database which comprises entries for prescription drugs and complementary treatments associated to at least some of the prescription drugs, the method comprising:
inputting a drug search criteria on a user interface, the drug search criteria corresponding to an identification of a drug prescribed to the patient;
obtaining, from the complementary treatment database, a list of complementary treatments matching the drug search criteria and hence adapted to the prescribed drug; and
outputting the list of complementary treatments on the user interface for consultation.

2. The method of claim 1, which further uses a database of patients which comprise entries for names of patients and, if any, incompatible treatments and a history of previous or present treatments, the method further comprising:
inputting, on the user interface, a patient search criteria corresponding to an identification of a given one of the patients;
obtaining, from the database of patients, a list of incompatible treatments and previous and present treatments for the given patient matching the patient search criteria;
wherein the obtaining of the list of complementary treatments comprises comparing the list of incompatible treatments and previous and present treatments for the patient matching the patient search criteria with the list of complementary treatments matching the drug search criteria, and producing the list of complementary treatments using the comparison of lists.

3. The method of claim 1, further comprising selecting a complementary treatment from the outputted list of complementary treatments.

4. The method of claim 3, wherein the selected complementary treatment comprises selecting a prescription drug, the method further comprising preparing and printing a prescription for the prescription drug.

5. The method of claim 3, further comprising providing supplementary information concerning the selected complementary treatment, the supplementary information comprising at least one of a promotion for a product, a document for the patient, and a document for the pharmacist giving arguments on the validity of the treatment.

6. The method of claim 3, wherein the selection of a complementary treatment triggers a query to the complementary treatment database which outputs, to the user interface, a list of products or services corresponding to the complementary treatment.

7. The method of claim 6, further comprising selecting a product or service from the list of products or services corresponding to the complementary treatment.

8. The method of claim 7, further comprising making a sale of the product or service.

9. The method of claim 8, further comprising recording the sale.

10. The method of claim 9, further comprising distributing revenue based on the recorded sale.

11. The method of claim 6, further comprising selling the position at which a product or service appears in the list of products or services.

12. A computer-readable medium encoded with processing instructions for implementing a method performed by a computer, the method being for outputting a list of complementary treatments for a patient using a complementary treatment database which comprises entries for prescription drugs and complementary treatments associated to at least some of the prescription drugs, the method comprising:
inputting a drug search criteria on a user interface, the drug search criteria corresponding to an identification of a drug prescribed to the patient;
obtaining, from the complementary treatment database, a list of complementary treatments matching the drug search criteria and hence adapted to the prescribed drug; and
outputting the list of complementary treatments on the user interface for consultation.

13. The computer-readable medium of claim 12, wherein the method further uses a database of patients which comprise entries for names of patients and, if any, incompatible treatments and a history of previous or present treatments, and wherein the method further comprises:
inputting, on the user interface, a patient search criteria corresponding to an identification of a given one of the patients; obtaining, from the database of patients, a list of incompatible treatments and previous and present treatments for the given patient matching the patient search criteria;
wherein the obtaining of the list of complementary treatments comprises comparing the list of incompatible treatments and previous and present treatments for the patient matching the patient search criteria with the list of complementary treatments matching the drug search criteria, and producing the list of complementary treatments using the comparison of lists.

14. A system for outputting a list of complementary treatments for a patient, the system comprising:
a user interface giving access to a network;
a complementary treatment database accessible via the network, the complementary treatment database comprises entries for prescription drugs and complementary treatments associated to at least some of the prescription drugs; and
a server processing unit coupled to the network and comprising a memory encoded with processing instructions for allowing the processor to:
input a drug search criteria on the user interface, the drug search criteria corresponding to an identification of a drug prescribed to the patient;
obtain, from the complementary treatment database, a list of complementary treatments matching the drug search criteria and hence adapted to the prescribed drug; and
output the list of complementary treatments on the user interface for consultation.

15. The system of claim 14, further comprising a database of patients accessible via the network, the database of patients which comprise entries for names of patients and, if any, incompatible treatments and a history of previous or present treatments, the memory further encoded with processing instructions for allowing the processor to:
input, on the user interface, a patient search criteria corresponding to an identification of a given one of the patients;
obtain, from the database of patients, a list of incompatible treatments and previous and present treatments for the given patient matching the patient search criteria;
wherein the obtaining of the list of complementary treatments comprises comparing the list of incompatible treatments and previous and present treatments for the patient matching the patient search criteria with the list of complementary treatments matching the drug search criteria, and producing the list of complementary treatments using the comparison of lists.
